(19) United States
(12) Patent Application Publication
(10) Pub. No.: US 2006/0158397 A1
(43) Pub. Date: Jul. 20, 2006

(54) Display device and driving method therefor

(76) Inventor: Joon-Chul Goh, Seoul (KR)

Correspondence Address: CANTOR COLBURN, LLP, 55 GRIFFIN ROAD SOUTH, BLOOMFIELD, CT, 06002, US

(21) Appl. No.: 11/330,624

(22) Filed: Jan. 11, 2006

(30) Foreign Application Priority Data
Jan. 14, 2005 (KR) 10-2005-0003679
Apr. 21, 2005 (KR) 10-2005-0033125

(51) Int. Cl. G09G 3/30

(52) U.S. Cl. 345/76

(57) ABSTRACT

A display device and a driving method of the same are provided. The display device includes: a light emitting element; a driving transistor having a control port connected to a first node, an output port connected to a second node, and an input port and applying a driving current to the light emitting element to emit light; a reference transistor having a control port connected to the first node, an output port connected to a third node, and an input port; a capacitor connected between the first and second nodes; and a resistive element connected between the second and third nodes.

This application claims priority to Korean Patent Applications No. 2005-0003679 and No 2005-0033125, respectively filed on Jan. 14, 2005 and Apr. 21, 2005, and all the benefits accruing therefrom under 35 U.S.C. §119, the contents of which are incorporated herein by reference in its entirety.

### BACKGROUND OF THE INVENTION

(a) Field of the Invention

The present invention relates to a display device and a driving method therefor, and more particularly, to an organic light emitting diode display device and a driving method therefor.

(b) Description of the Related Art

Recently, as thin and light-weight types of personal computers and television sets have been required, cathode ray tubes (CRTs) have been replaced with flat display devices.

As the flat display devices, there are liquid crystal display (LCD) apparatuses, field emission display (FED) apparatuses, organic light emitting diode display (OLED) apparatuses, plasma display panel (PDP) apparatuses, and the like.

In general, in an active type flat display device, a plurality of pixels are arrayed in matrix, and an intensity of light of the pixels are controlled according to given brightness information, so that an image is displayed. The organic light emitting diode display device is a display device which electrically excites phosphorous organic materials to display the image. As a self emitting apparatus with low power consumption, a wide viewing angle, and a high response speed, the organic light emitting diode display device can easily display a high quality moving image.

The organic light emitting diode display device includes organic light emitting diodes (OLEDs) and thin film transistors (TFTs) which drive the organic light emitting diodes. The thin film transistors are classified into polysilicon thin film transistors and amorphous silicon thin film transistors according to types of active layers. Due to several advantages, the organic light emitting diode display device employing the polysilicon thin film transistors have been generally used. However, manufacturing processes for the thin film transistors are complex, and thus, production costs increase. In addition, it is difficult to obtain a wide screen by using the organic light emitting diode display devices.

By using the organic light emitting diode display device employing the amorphous silicon thin film transistors, a wide screen can be easily obtained. In addition, the number of production processes thereof is relatively smaller than that of the organic light emitting diode display device employing the polysilicon thin film transistors. However, as the amorphous silicon thin film transistors continuously supply a current to the organic light emitting diodes, the threshold voltage of the amorphous silicon thin film transistors may deteriorate. Even though the same data voltage is applied, non-uniform current flows through the organic light emitting diodes, so that the image quality of the organic light emitting diode display device deteriorates.

As a current flows through organic light emitting diodes for a long time, the threshold voltage thereof is transitioned. In case of an n-type thin film transistor, the organic light emitting diode is located on the source side of the thin film transistor. Therefore, if the threshold voltage of the organic light emitting diodes deteriorates, the voltage of the source electrode of the thin film transistor varies. As a result, even though the same voltage is applied to the gate electrode of the thin film transistor, the voltages of the gate and source electrodes of the thin film transistor are different from each other, so that the non-uniform current flows through the organic light emitting diodes. For the reason, the image quality of the organic light emitting diode display device also deteriorates.

On the other hand, as the driving voltage used to supply a current to the organic light emitting diodes through the thin film transistors becomes higher and higher, the heat released from the organic light emitting diode display device increases. Due to the heat, the devices of the organic light emitting diode display device can easily deteriorates.

### SUMMARY OF THE INVENTION

The present invention provides a display device with amorphous silicon thin film transistors capable of compensating for deterioration in threshold voltages of the amorphous silicon thin film transistors and organic light emitting diodes and displaying images with a relatively low driving voltage and a driving method therefor.

An exemplary embodiment provides a display device including a light emitting element; a driving transistor having a control port connected to a first node, an output port connected to a second node, and an input port and supplying a driving current to the light emitting element to emit light; a reference transistor having a control port connected to the first node, an output port connected to a third node, and an input port; a capacitor connected between the first and second nodes; and a resistive element connected between the second and third nodes.

Another exemplary embodiment provides a driving method for a display device comprising a driving transistor having a control port connected to a first node, an output port connected to a second node, and an input port; a reference transistor having a control port connected to the first node, an output port connected to a third node, and an input port; a light emitting element connected to the first node; a capacitor connected between the first and second nodes; and a resistive element connected between the second and third nodes, the driving method comprising steps of: applying a reference voltage to the input port of the driving transistor; supplying a precharge voltage to the first node; supplying a data voltage to the third node; discharging a voltage charged in the first node through the reference transistor; discharging a voltage charged in the third node through the resistive element; and applying a driving voltage to the input port of the driving transistor.

Another exemplary embodiment provides a display device comprising a light emitting element; a first transistor having a first port, a second port, and a third port connected to the light emitting element; a second transistor having a first port connected to the first port of the first transistor, a second port connectable to the first port, and a third port connectable to a data voltage; and a capacitor connected between the first port and the third port of the first transistor.

Another exemplary embodiment provides a driving method for a display device comprising a light emitting element; a first transistor having a first port connected to a first node, a second port connected to a second node and the light emitting element, and a third port; a second transistor having a first port connected to the first node, a second port, and a third port; and a capacitor connected between the first node and the second node, the driving method comprising steps of: applying a first voltage for suppressing emission of the light emitting element to the third port of the first transistor; connecting a second voltage higher than the first voltage to the first node; after the second voltage is connected to the first node, disconnecting the first node from the second voltage; after the first node is disconnected from the second voltage, connecting a data voltage lower than the second voltage to the second port of the second transistor; after the first node is disconnected from the second voltage, connecting the first port and the third port of the second transistor; after the second port and the first port of the second transistor are connected to the data voltage and the third port thereof, respectively, disconnecting the third port of the second transistor from the first port thereof; after the second port and the first port of the second transistor are connected to the data voltage and the third port thereof, respectively, disconnecting the second port of the second transistor from the data voltage; after the first port and second port of the second transistor are disconnected from the third port thereof and the data voltage, respectively, connecting the second port of the second transistor to the second node; and applying a third voltage to the third port of the first transistor, thereby allowing the light emitting element to emit light.

Another exemplary embodiment provides a driving method for a display device comprising: a light emitting element; a first transistor having a first port, a second port, and a third port connected to the light emitting element; a second transistor having a first port connected to the first port of the first transistor, a second port, and a third port; and a capacitor between the first port and the third port of the first transistor, the driving method comprising steps of: applying a first voltage to the second port of the first transistor, thereby suppressing emission of the light emitting element; charging a second voltage higher than the first voltage in the first port of the first transistor; discharging the first port of the first transistor toward a data voltage lower than the second voltage through the second transistor, thereby reducing a voltage of the first port of the first transistor; connecting the third port of the second transistor to the third port of the first transistor; and applying a third voltage to the second port of the first transistor, thereby allowing the light emitting element to emit light.

Another exemplary embodiment provides a display device comprising a plurality of pixel rows of pixels, wherein each of the pixels comprises a light emitting element; a first transistor having a first port, a second port, and a third port connected to the light emitting element; a second transistor having a first port connected to the first port of the first transistor, a second port connectable to the first port of the first transistor, and a third port alternately connected to the third port of the first transistor and a data voltage; and a capacitor connected between the first port and the second port of the first transistor, and wherein the pixels of at least two pixel rows simultaneously emit light.

Another exemplary embodiment provides a display device comprising a light emitting element; a driving transistor having an input port connected to one of a driving voltage and a reference voltage lower than the driving voltage, a control port, and an output port connected to the light emitting element; and a capacitor connected to the control port and the output port of the driving transistor to charge a precharge voltage different from the driving voltage and, after that, store a control voltage depending on a data voltage.

Another exemplary embodiment provides a display device comprising a precharge voltage line which transmits a precharge voltage and is connectable to a first node; a light emitting signal line which transmits a light emitting signal including a driving voltage and a reference voltage lower than the driving voltage; a light emitting element connected to a second node; a driving transistor having a control port connected to the first node, an input port connected to the light emitting element, and an output port connected to the second node; a reference transistor having a control port connected to the first node, an input port, and an output port connected to a third node; and a capacitor connected between the first node and the second node

Another exemplary embodiment provides a driving method for a display device comprising a driving transistor having an input port, a control port, and an output port; a capacitor connected between the control port and the output port of the driving transistor; and a light emitting element connected to the output port of the driving transistor, the driving method comprising steps of: applying a reference voltage to the input port of the driving transistor; applying a precharge voltage higher than the reference voltage to the control port of the driving transistor, thereby charging the capacitor; applying a data voltage lower than the precharge voltage to discharge a voltage charged in the capacitor in the step of charging, thereby charging the capacitor with a control voltage depending on the data voltage; and applying a driving voltage higher than the reference voltage to the input port of the driving transistor.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing an exemplary embodiment of an organic light emitting diode display device according to the present invention;

FIG. 2 is an equivalent circuit diagram showing an exemplary embodiment of a pixel of the organic light emitting diode display device according to the present invention;

FIG. 3 is a cross sectional view showing an exemplary embodiment of a cross section of a driving transistor and an organic light emitting diode of a pixel of the organic light emitting diode display device shown in FIG. 2;

FIG. 4 is a schematic view showing an exemplary embodiment of an organic light emitting diode of the organic light emitting diode display device according to the present invention;

FIG. 5 is a timing diagram showing an exemplary embodiment of a driving signal of the organic light emitting diode display device according to the present invention;

FIG. 6 is an equivalent circuit diagram showing another exemplary embodiment of a pixel of an organic light emitting diode display device according to the present invention;

FIG. 7 is a schematic view showing another exemplary embodiment of an organic light emitting diode of the organic light emitting diode display device according to the present invention;

FIG. 8 is a timing diagram showing an exemplary embodiment of a driving signal of the organic light emitting diode display device shown in FIG. 7;

FIG. 9 is a schematic view showing another exemplary embodiment of an organic light emitting diode of the organic light emitting diode display device according to another embodiment of the present invention; and

FIG. 10 is a timing diagram showing an exemplary embodiment of a driving signal of the organic light emitting diode display device shown in FIG. 9.

### DETAILED DESCRIPTION OF THE INVENTION

Hereinafter, exemplary embodiments of the present invention will be described in detail with reference to the attached drawings such that the present invention can be easily put into practice by those skilled in the art.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “above” other elements or features would then be oriented “below” the other elements or features. Thus, the exemplary term “above” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

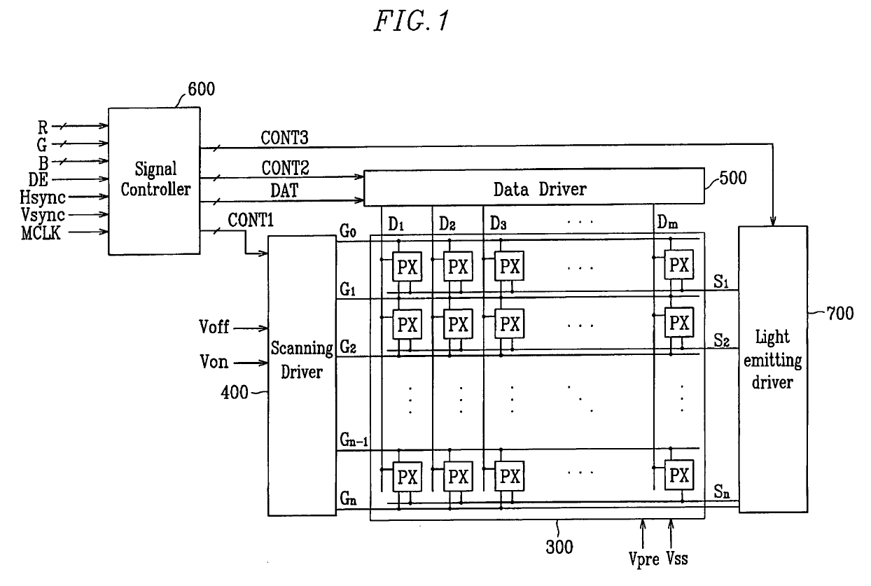

Firstly, an exemplary embodiment of an organic light emitting diode display device according to the present invention will be described with reference to FIGS. 1 to 5.

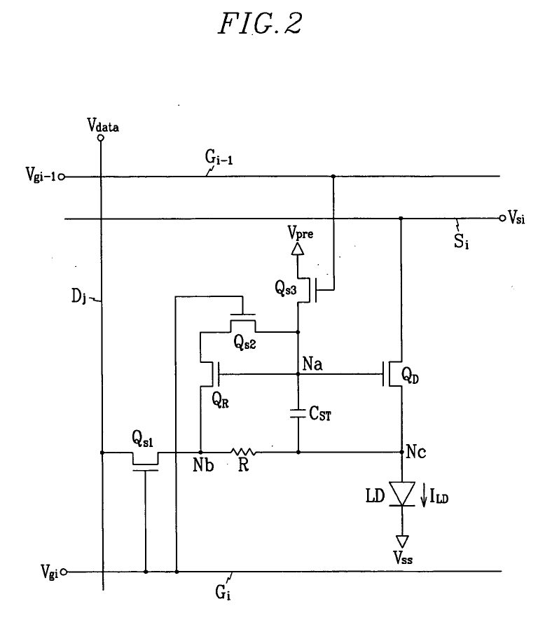

FIG. 1 is a block diagram showing an exemplary embodiment of an organic light emitting diode display device according to the present invention, and FIG. 2 is an equivalent circuit diagram showing an exemplary embodiment of a pixel of the organic light emitting diode display device according to the present invention.

As shown in FIG. 1, the organic light emitting diode display device according to the embodiment of the present invention includes a display panel 300, scan, data, light emitting drivers 400, 500, and 700 which are connected to the display panel 300, and a signal controller 600 which controls the drivers.

As seen in the equivalent circuit diagram, the display panel 300 include a plurality of signal lines G₀ to Gₙ, D₁ to Dₘ, and S₁ to Sₙ, a plurality of voltage lines (not shown), and a plurality of pixels PX which are connected to the lines and arrayed substantially in matrix.

The signal lines include a plurality of scan signal lines G₀ to Gₙ which transmit scan signals Vg₀ to Vgₙ, data lines D₁ to Dₘ which transmit data signals Vdata, and a plurality of light emitting signal lines S₁ to Sₙ which transmit light emitting signals Vs₁ to Vsₙ. The scan signal lines G₀ to Gₙ and the light emitting signal lines S₁ to Sₙ extend substantially in the row direction and are substantially parallel to each other, and the data lines D₁ to Dₘ extend substantially in the column direction and are substantially parallel to each other.

The voltage lines include precharge voltage lines (not shown) which transmit a precharge voltage Vpre.

As shown in FIG. 2, an exemplary embodiment of the pixels PX, for example of a pixel connected to the scan signal line Gᵢ and the data line Dⱼ, include an organic light emitting diode LD, a driving transistor Qd, a reference transistor Qr, a capacitor Cst, a resistor R, and three switching transistors Qs1, Qs2, and Qs3.

The driving transistor Qd has a control port, an input port, and an output port. The control port is connected to a node Na which the reference transistor Qr, the switching transistors Qs2 and Qs3, and the capacitor Cst are connected to; the input port is connected to a light emitting signal Vₛᵢ; and the output port is connected to a node Nc which the organic light emitting diode LD is connected to.

The reference transistor Qr also has a control port, an input port, and an output port. The control port is connected to the node Na; the input port is connected to the switching transistor Qs2; and the output port is connected to a node Nb which the switching transistor Qs1 and the resistor R are connected to.

The capacitor Cst is connected between the node Na and the node Nc.

The resistor R is connected between the node Nb and the node Nc. The resistor R may be constructed with a semiconductor or a conductor. In exemplary embodiments, amorphous silicon or polysilicon may be used as the semiconductor, or amorphous silicon or polysilicon doped with n+ type impurities may be used.

An anode (not shown) and a cathode (not shown) of the organic light emitting diode LD are connected to the node Nc and a common voltage Vss. The organic light emitting diode LD emits light with different intensities according to an amount of a current ILD supplied by the driving transistor Qd, so that images can be displayed. The amount of the current ILD greatly depends on a magnitude of a voltage Vgs between the control port and the output port of the driving transistor Qd.

The switching transistor Qs1 is connected to the scan signal line Gᵢ, the data voltage Vdata, and the node Nb and operates in response to a scan signal Vgᵢ.

The switching transistor Qs2 is connected to the scan signal line Gᵢ, the input port of the reference transistor Qr, and the node Na and operates in response to the scan signal Vgᵢ.

The switching transistor Qs3 is connected to a front-stage scan signal line Gᵢ₋₁, the precharge voltage Vpre, and the node Na and operates in response to the front-stage scan signal Vgᵢ₋₁.

In exemplary embodiments, the transistors Qd, Qr, and Qs1 to Qs3 may be an n-channel field effect transistor (FET) made of amorphous silicon or polysilicon. In alternative embodiments, the transistors Qd, Qr, and Qs1 to Qs3 may be a p-channel field effect transistor, and in this case, since the p-channel and n-channel field effect transistors are complementary to each other, the operation, voltage, and current of the p-channel field effect transistor are opposite to those of the n-channel field effect transistor.

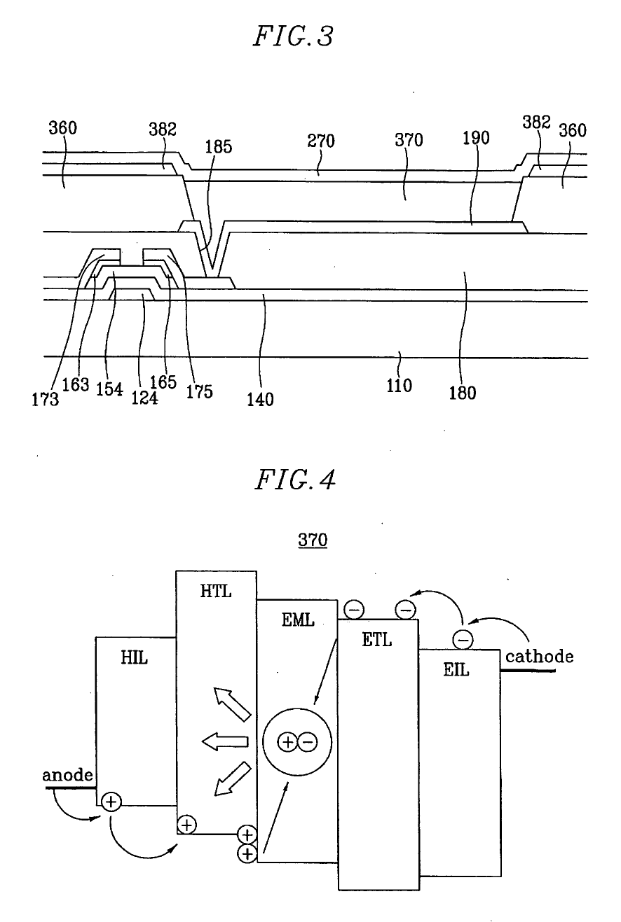

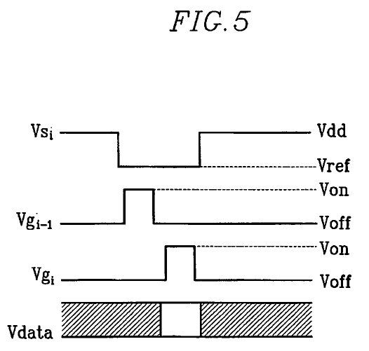

Now, structures of the driving transistor Qd and the organic light emitting diode LD of the organic light emitting diode display device shown in FIG. 2 will be described in detail with reference to FIGS. 3 and 4.

FIG. 3 is a cross sectional view showing an exemplary embodiment of a cross section of a driving transistor and an organic light emitting diode of a pixel of the organic light emitting diode display device shown in FIG. 2. FIG. 4 is a schematic view showing an exemplary embodiment of an organic light emitting diode of the organic light emitting diode display device according to the present invention.

A control electrode 124 is formed on an insulating substrate 110. The control electrode 124 may be made of an aluminum based metal such as aluminum (Al) and an aluminum alloy, a silver based metal such as silver (Ag) and a silver alloy, a copper based metal such as copper (Cu) and copper alloy, a molybdenum based metal such as molybdenum (Mo) and a molybdenum alloy, chromium (Cr), titanium (Ti), or tantalum (Ta). In exemplary embodiments, the control electrode 124 may have a multi-layered structure including two conductive layers (not shown) having different physical properties. One of the two conductive layers may be made of a metal having a low resistivity, for example, an aluminum based metal, a silver based metal, and a copper based metal, in order to reduce signal delay or voltage drop. The other conductive layer may be made of a material having good physical, chemical, and electrical contactness to other materials, particularly, ITO (indium tin oxide) and IZO (indium zinc oxide) such as a molybdenum based metal, chromium, titanium, and tantalum. Alternative embodiments include configurations where there are a combination of a lower chromium layer and an upper aluminum (alloy) layer and a combination of a lower aluminum (alloy) layer and an upper molybdenum (alloy) layer. However, the control electrode 124 may be made of various metals and conductive materials suitable for the purpose described herein. Referring again to FIG. 3, the control electrode 124 is slanted with respect to a surface of the substrate 110. The slanted angle may be in a range of about 30° to about 80°.

An insulating layer 140 which may include, but is not limited to a silicon nitride SiNₓ or the like, is formed on the control electrode 124.

Semiconductors 154 that may include, but are not limited to, a hydrogenated amorphous silicon (abbreviated to a-Si) are formed on the insulating film 140. A pair of ohmic contact members 163 and 165 that may include, but are not limited to, a silicide or an n+ hydrogenated amorphous silicon or the like which are doped with n-type impurities are formed above the semiconductors 154. As illustrated in FIG. 3, side surfaces of the semiconductors 154 and the ohmic contact members 163 and 165 may be slanted with respect to the surface of the substrate 110, and the slanted angle may be in a range of about 30° to about 80°.

An input electrode 173 and an output electrode 175 are formed on the ohmic contact members 163 and 165 and the insulating film 140. The input electrode 173 and the output electrode 175 may be made of chromium, a molybdenum based metal, or a refractory metal such as tantalum and titanium and may have a multi-layered structure which is constructed with a lower layer (not shown) made of the refractory metal and an upper layer (not shown) made of a low resistance material disposed thereon. Alternative embodiments include configurations where the multi-layered structure includes a two-layered structure of a lower chromium or molybdenum (alloy) layer and an upper aluminum layer and a three-layered structure of a lower molybdenum (alloy) layer, an intermediate aluminum (alloy) layer, and an upper molybdenum (alloy) layer. Similar to the input electrode 124 and the like, side surfaces of the input electrode 173 and the output electrode 175 may also be slanted with a slanted angle of about 30° to about 80°.

The input electrode 173 and the output electrode 175 are separated from each other, such as by a channel, and disposed at the respective sides of the control electrode 124. The control electrode 124, the input electrode 173, and the output electrode 175 together with semiconductors 154 constitute the driving transistor Qd, and the channel thereof is formed on the semiconductor 154 between the input electrode 173 and the output electrode 175.

Referring to FIG. 3, the ohmic contact members 163 and 165 are interposed between the underlying semiconductors 154 and the overlying input and output electrodes 173 and 175 and have a function of reducing contact resistance. The semiconductors 154 have an exposed portion uncovered between the input electrode 173 and the output electrode 175.

A protective film (passivation layer) 180 is formed on the input electrode 173, the output electrode 175, the exposed portion of the semiconductor 154, and the insulating film 140. The protective film 180 may be made of an inorganic material such as a silicon nitride and a silicon oxide, an organic material, or a low dielectric-constant insulating material. Exemplary embodiments of the protective film 180 include configurations where the dielectric constant of the lower dielectric-constant insulating material is preferably 0.4 or less, and a-Si:C:O and/or include a-Si:O:F formed with a plasma enhanced chemical vapor deposition (PECVD). In alternative embodiments, the protective film 180 may be made of an organic material having a photosensitivity, and a surface of the protective film 180 may be planarized. In addition, in order to use excellent properties of an organic film and protect the exposed portion of the semiconductor 154, the protective film 180 may have a two-layered structure of a lower inorganic film and an upper organic film. Referring again to FIG. 3, in the protective film 180, a contact hole 185 is formed which exposes the output electrode 175.

A pixel electrode 190 is formed on the protective film 180. The pixel electrode 190 is physically and electrically connected through the contact hole 185 to the output electrode 175 and may be made of a transparent conductive material such as ITO and IZO or a metal having an excellent reflectance such as aluminum or a silver alloy.

Partition walls 360 are formed on the protective film 180. The partition walls 360, like a bank, surround the pixel electrode 190 to define an opening and may be made of an organic insulating material or an inorganic insulating material.

Referring to FIG. 3, an organic light emitting element 370 is formed on the pixel electrode 190, and the organic light emitting element 370 is enclosed by the partition walls 360.

As shown in FIG. 4, the organic light emitting element 370 has a multi-layered structure including a light emitting layer (EML) and auxiliary layers for improving light emitting efficiency of the light emitting layer. Auxiliary layers include, but are not limited to, an electron transport layer (ETL) and a hole transport layer (HTL) which balance electrons and holes and an electron injecting layer (EIL) and an hole injecting layer (HIL) which enhance injection of the electrons and the holes. Alternative embodiments include configurations where the auxiliary layers may be omitted.

An auxiliary electrode 382 that may be made of a conductive material having a low resistivity such as a metal is formed on the partition walls 360.

A common electrode 270 applied with a common voltage is formed on the partition walls 360, the organic light emitting element 370, and the auxiliary electrode 382. The common electrode 270 may be made of a reflective metal such as calcium (Ca), barium (Ba), and aluminum (Al) or a transparent conductive material such as ITO and IZO.

The auxiliary electrode 382 contacts the common electrode 270 to compensate for the conductivity of the common electrode 270 so as to prevent voltage distortion of the common electrode 270.

In exemplary embodiments, an opaque pixel electrode 190 and an opaque common electrode 270 are employed in a top emission type organic light emitting diode display device where an image is displayed in the upward direction of the display panel 300. In alternative embodiments, a transparent pixel electrode 190 and a transparent common electrode 270 are employed in a bottom emission type organic light emitting diode display device where images are displayed in the downward direction of the display panel 300.

The pixel electrode 190, the organic light emitting element 370, and the common electrode 270 constitute the organic light emitting diode LD shown in FIG. 2. Here, the pixel electrode 190 and the common electrode 270 become the anode and the cathode, respectively. Alternatively, the pixel electrode 190 and the common electrode 270 become the cathode and the anode, respectively. The organic light emitting diode LD emits light of one of primary colors according to a material of the organic light emitting element 370. An example of the primary colors includes, but is not limited to, red, green, and blue. In alternative embodiments, a desired color can be obtained by a spatial combination of the primary colors.

Returning to FIG. 1, the scanning driver 400 is connected to the scan signal lines G₀ to Gₙ of the display panel 300 to apply the scan signal Vgᵢ constructed with a combination of high and low voltages Von and Voff which turn on and off the switching transistors Qs1 to Qs3 to the scan signal lines G₀ to Gₙ.

The data driver 500 are connected to the data lines D₁ to Dₘ of the display panel 300 to apply the data voltage Vdata representing the image signal to the data lines D₁ to Dₘ.

The light emitting driver 700 are connected to the light emitting signal lines S₁ to Sₙ to apply the light emitting signal Vsᵢ constructed with a combination of the driving and reference voltages Vdd and Vref to the light emitting signal lines S₁ to Sₙ.

The scanning driver 400, the data driver 500, and/or the light emitting driver 700 may be directly mounted in a form of a plurality of driving IC chips on the display panel 300. Alternatively, the scanning driver 400, the data driver 500, and/or the light emitting driver 700 may be attached in a form of a tape carrier package (TCP) on flexible printed circuit (FPC) film (not shown) in the display panel 300. In other alternative embodiments the scanning driver 400, the data driver 500, or the light emitting driver 700 together with the signal lines G₀ to Gₙ, D₁ to Dₘ, and S₁ to Sₙ, the transistors Qd, Qr, and Qs1 to Qs3, and the like may be directly mounted on the display panel 300.

The signal controller 600 controls operations of the scanning driver 400, the data driver 500, and the light emitting driver 700.

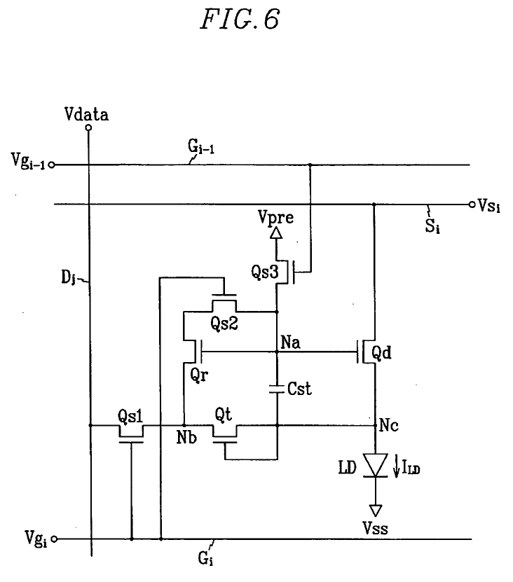

Now, the operations of the organic light emitting diode display device will be described in detail with reference to FIG. 5.

FIG. 5 is a timing diagram showing an exemplary embodiment of a driving signal of the organic light emitting diode display device according to the present invention.

The signal controller 600 receives input image signals R, G, and B and input control signals for controlling display thereof from an external graphic controller (not shown). The input control signals may include, but are not limited to, a vertical synchronization signal Vsync, a horizontal synchronization signal Hsync, a main clock MCLK, and a data enable signal DE are received. The signal controller 600 processes the image signals R, G, and B according to an operating condition of the liquid display panel assembly 300 based on the input control signals and the input image signals R, G, and B to generate a scan control signal CONT1, a data control signal CONT2, and a light emitting control signal CONT3. The signal controller 600 transmits the generated scan control signal CONT1 to the gate driver 400, the generated data control signal CONT2 and the processed image signal DAT to the data driver 500, and the generated light emitting control signal CONT3 to the light emitting driver 700.

The scan control signal CONT1 may include, but is not limited to, a vertical synchronization start signal STV for indicating scan start of the high voltage Von, at least one clock signal for controlling an output of the high voltage Von, and the like. The scan control signal CONT1 also may include an output enable signal OE for defining a duration time of the high voltage Von.

The data control signal CONT2 may include, but is not limited to, a horizontal synchronization start signal STH for indicating data transmission for one pixel row, a load signal LOAD for commanding to apply the associated data voltages to the data lines D₁ to Dₘ, a data clock signal HCLK, and the like.

Now, the following description is concentrated on a specific pixel row, for example, the i-th row.

Firstly, the light emitting driver 700 generates the light emitting signal Vsᵢ as the reference voltage Vref according to the light emitting control signal CONT3 from the signal controller 600. While the data lines D₁ to Dₘ transmit the data voltage corresponding to the front stage pixel row, that is, the (i−1)-th pixel row, the scanning driver 400 converts the scan signal Vgᵢ₋₁ corresponding to the front-stage scan signal line, that is, the (i−1)-th scan signal line Gᵢ₋₁ into the high voltage Von according to the scan control signal CONT1. Accordingly, the switching transistor Qs3 of the i-th pixel row connected to the front-stage scan signal line Gᵢ₋₁ turns on. At this time, since the scan signal Vgᵢ transmitted by the i-th scan signal line Gᵢ is the low voltage Voff, the two different switching transistors Qs1 and Qs2 of the i-th pixel row are in a turn-off state. Hereinafter, the time interval is referred to as a precharge period.

Next, the node Na is applied with the precharge voltage Vpre, and the voltage Vpre is sustained by the capacitor Cst. The precharge voltage Vpre is set to a value which is much higher than the data voltage Vdata and the reference voltage Vref. On the other hand, the reference voltage Vref is set to a value which is equal to or lower than a threshold voltage Vtho of the organic light emitting diode LD with respect to the common voltage Vss. Therefore, even though the reference voltage Vref is applied to the node Nc by turning on the driving transistor Qd during the precharge period, since the organic light emitting diode LD does not flow a current, the organic light emitting diode LD cannot emit light. A voltage difference between the nodes Na and Nc is stored in the capacitor Cst.

Next, the data driver 500 receives the image data DAT corresponding to the pixels PX of the i-th pixel row, converts the image data DAT into an analog data voltage Vdata, and applies the analog data voltage Vdata to the data lines D₁ to Dₘ according to the data control signal CONT2 from the signal controller 600.

Before the data voltage Vdata is applied to the i-th pixel row, the scanning driver 400 converts the front-stage scan signal Vgᵢ₋₁ into the low voltage Voff to turn off the switching transistor Qs3, and when or after the data voltage Vdata is applied to the i-th pixel row, the scanning driver 400 converts the scan signal Vgᵢ into the high voltage Von to turn on the switching transistors Qs1 and Qs2, so that a data input period starts.

During the data input period, the light emitting signal Vsᵢ is sustained in the reference voltage Vref, and the switching transistor Qs1 applies the data voltage Vdata to the node Nb.

At this time, since a resistance value of the resistor R is set to a sufficiently large value, the current flowing between the nodes Nb and Nc is very small. For example, if the resistance value of the resistor R, the data voltage Vdata, and the reference voltage Vref are 10⁹, 13V, and 3V, respectively, a current of 10 nA flows though the resistor R. Since the very small current flows through the resistor R, the node Nb is sustained in the data voltage Vdata, and the node Nc is sustained in the reference voltage Vref.

Since the precharge voltage Vpre is larger than the data voltage Vdata, the reference transistor Qr turns on when the data input period starts. Accordingly, charges which are charged in the capacitor Cst are discharged through the switching transistor Qs2, the reference transistor Qr, and the switching transistor Qs1. The discharging proceeds until the voltage difference between the control port and the output port of the reference transistor Qr becomes the threshold voltage Vthr of the reference transistor Qr. Here, a voltage VA of the node Na converges into a voltage as follows. As the precharge voltage Vpre becomes larger, the voltage VA converges into the voltage more and more stably.
VA=Vthr+Vdata [Equation 1]

Here, if the reference and driving transistors Qr and Qd on the one pixel are disposed to be close to each other and have different structures, the threshold value Vthr of the reference transistor Qr is equal to the threshold voltage Vthd of the driving transistor Qd. Accordingly, the voltage Vgs between the control port and the output port of the driving transistor Qd are obtained as follow. The voltage Vgs is stored in the capacitor Cst.
Vgs=Vthd+Vdata−Vref [Equation 2]

After that, the scanning driver 400 converts the scan signal Vgᵢ into the low voltage Voff to turn off the switching transistors Qs1 and Qs2 according to the scan control signal CONT1. As a result, the node Na is in a floating state, and the node Nb is disconnected from the data voltage Vdata. Therefore, the charges which are charged in a parasite capacitor are discharged through the resistor R to the node Nc, so that the voltage of the node Nb is equal to the voltage of the node Nc. The time interval that it is takes for the voltage of the node Nb to approach to the voltage of the node Nc is determined based on a time constant τ which is a product of a parasite capacitance formed at the node Nb and the resistance of the resistor R. The time constant τ is equal to a time interval that it takes for the voltage of the node Nb to approach to about 63.2% of the voltage of the node Nc. If the parasite capacitance of the node Nb and the resistance of the resistor R are 0.01 pF and 10⁹, respectively, the time constant τ is 10 μs. In this case, when a time interval of about 30 μs elapses, the voltage of the node Nb approaches to 96% of the voltage of the node Nc.

After the scan signal Vgᵢ is converted into the low voltage Voff, when a predetermined time interval elapses, the light emitting driver 700 converts the light emitting signal Vₛᵢ into the driving voltage Vdd according to the light emitting control signal CONT3 from the signal controller 600, so that a light emitting period starts. The driving voltage Vdd is set to a suitably high value, so that the driving transistor Qd can operate in a saturation region. Accordingly, the driving transistor Qd supplies an output current I_{LD} which is controlled based on the voltage difference Vgs between the control port and the output port of the driving transistor Qd through the output port to the organic light emitting diode LD. The organic light emitting diode LD emits light with different intensities according to the output current I_{LD}, so that the associated image can be displayed.

When a current flows, the voltage of the node Nc increases. However, since the control port of the driving transistor Qd is in the floating state, the voltage charged in the capacitor Cst is sustained. The driving current I_{LD} flowing through the organic light emitting diode LD by the driving transistor Qd during the light emitting period is determined irrespective of the threshold voltage Vthd of the driving transistor and the threshold voltage Vtho of the organic light emitting diode LD, as follows.

$$\begin{matrix}{I}_{LD} = 1 / 2 \times K \times {( Vgs - Vthd )}^{2} \\ = 1 / 2 \times K \times {( Vthd + Vdata - Vref - Vthd )}^{2} \\ = 1 / 2 \times K \times {( Vdata - Vref )}^{2}\end{matrix} \qquad [ Equation 3 ]$$

Here, K is a constant according to characteristics of a thin film transistor, that is, K=μ·Ci·W/L. Here, μ denotes a field effect mobility; Ci denotes a capacitance of an insulating layer; W denotes a channel width of the driving transistor Qd; and L denotes a channel length of the driving transistor Qd.

The threshold voltages Vthd and Vthr of the driving and reference transistors Qd and Qr can easily vary due to a stress applied thereto during the operations thereof. In particular, in a case where the two transistors Qd and Qr include amorphous silicon, the phenomenon is greatly dominated. If the threshold voltages Vthd and Vthr are different from each other due to the different stresses applied to the two transistors Qd and Qr, the above description is not stratified, so this case must be taken into consideration.

The main stresses applied to the driving transistor Qd and the reference transistor Qr are the voltage differences Vgs between the control ports and the output ports of the transistors Qd and Qr. Since the control ports of the driving transistor Qd and the reference transistor Qr are connected to each other, the voltages thereof are always equal to each other. In addition, the voltage of the output port of the driving transistor Qd is the voltage of the node Nc, and the voltage of the output port of the reference transistor Qr is the voltage of the node Nb. The voltages of the nodes Nb and Nc are different from each other only in the time interval of input of the data voltage Vdata during the data input period, but the voltages thereof are equal to each other in the other time intervals. If the number of the scan signal lines G₁ to Gₙ is 1,000, the data input period merely occupies about 0.1% of a frame. Therefore, since the time interval that the voltages of the nodes Nb and Nc are different from each other merely occupies 0.1% of the total time interval, the voltages of the nodes Nb and Nc are substantially equal to each other. Accordingly, the voltage difference between the control port and the output port of the reference transistor Qr is also substantially equal to that of the driving transistor Qd, so that a variation range of the threshold voltage Vthr of the reference transistor Qr is substantially equal to that of the driving transistor Qd.

As a result, the threshold voltage Vthr of the reference transistor Qr is substantially equal to the threshold voltage Vthd of the driving transistor Qd.

On the other hand, the values of W/L of the driving transistor Qd and the reference transistor Qr may be designed to be different from each other, so that the threshold voltages Vthd and Vthr of the two transistors Qd and Qr can be different from each other. In this case, Equations 2 and 3 change into the following Equations 4 and 5.
Vgs=Vthr+Vdata−Vref [Equation 4]

$$\begin{matrix}{I}_{LD} = 1 / 2 \times K \times {( Vgs - Vthd )}^{2} \\ = 1 / 2 \times K \times {( Vthr + Vdata - Vref - Vthd )}^{2} \\ = 1 / 2 \times K \times {\{ Vdata - Vref + ( Vthr - Vthd ) \}}^{2}\end{matrix} \qquad [ Equation 5 ]$$

If the display panel 300 is designed so as for the threshold voltage differences Vthr−Vthd between the driving and reference transistors Qd and Qr to be uniform over all the pixels, that is, so as for the threshold voltage voltages Vthr−Vthd to be constant, all the pixels display with the same brightness with respect to a given one date voltage, so that it is possible to display an image without any defects. In addition, as described above, since the variation values of the threshold voltages Vthr and Vthd of the driving and reference transistors Qd and Qr are equal to each other irrespective of the W/L, even though the threshold voltages Vthr and Vthd vary, the difference Vthr−Vthd between the threshold voltages Vthr and Vthd of the driving and reference transistors Qd and Qr is constant.

Since the characteristics of the transistors Qd and Qr are uniform over the display panel 300, it is possible to compensate for the variation of the threshold voltages. As a result, in order to simplify production processes and increase an aperture ratio, the size of the reference transistor Qr can be designed to be smaller than the size of the driving transistor Qd.

Advantageously, where the threshold voltages of the driving and reference transistors Qd and Qr are equal to each other, even though the characteristics of the transistors Qd and Qr are different among the pixels, it is possible to compensate for the variation of the threshold voltage Vthd of the driving transistor Qd.

The light emitting period proceeds until the precharge period for the pixels PX of the i-th pixel row in the next frame starts again, and the operations of the aforementioned periods repeat for the pixels PX of the next pixel row. In this manner, the period control is sequentially performed on all of the scan signal lines G₀ to Gₙ and the light emitting signal lines S₁ to Sₙ, so that the associated image is displayed on the pixels PX. Here, the scan signal line G₀ and the scan signal Vg₀ are used to display an image on the pixels PX of the first pixel row.

The lengths of the periods may be adjusted as needed.

In the exemplary embodiments discussed above, the transitions of the threshold voltages Vthd and Vtho of the driving transistor Qd and the organic light emitting diode LD can be compensated. Advantageously, it is possible to reduce or effectively prevent deterioration in image quality.

In alternative embodiments, in order to compensate for the transitions of the threshold voltages Vthd and Vtho, the driving voltage Vdd may be used as a precharge voltage. In this case, for the stable compensation, the driving voltage Vdd must be sufficiently high. However, as described above, if the driving voltage Vdd is too high, heat released from the organic light emitting diode display device increases, so that the devices in the organic light emitting diode display device can easily deteriorate. As discussed in the exemplary embodiments, since a separate precharge voltage Vpre different from the driving voltage Vdd is used, the precharge voltage Vpre is allowed to be set to a sufficiently high value, so that the driving voltage Vdd can be set to a relatively small value. Accordingly, it is possible to reduce heat released from the organic light emitting diode display device and to limit or effectively prevent deterioration of the organic light emitting diode display device caused by the heat.

Now, an exemplary embodiment of an organic light emitting diode display device according to the present invention will be described in detail with reference to FIG. 6.

FIG. 6 is an equivalent circuit diagram showing another exemplary embodiment of a pixel of an organic light emitting diode display device according to the present invention.

As shown in FIG. 6, in the exemplary embodiment of an organic light emitting diode display device according to the present invention, each of the pixels PX includes an organic light emitting diode LD, a driving transistor Qd, a reference transistor Qr, a capacitor Cst, a transistor Qt, and three switching transistors Qs1, Qs2, and Qs3.

In the pixel PX shown in FIG. 6, the resistor R of the pixel PX shown in FIG. 2 is replaced with the transistor Qt. Except for the transistor Qt, the two pixels are substantially the same, and thus, the description on the same components will be omitted.

The transistor Qt is connected between the node Nb and the node Nc, and a control port (gate) thereof is connected to the node Nc. Alternatively, the control port of the transistor Qt may be connected to the node Nb.

In the data input period, the voltage of the node Nb is the data voltage Vdata, and the voltage of the node Nc is the reference voltage Vref.

In a case where the data voltage Vdata is higher than the reference voltage Vref, the node Nb becomes a drain of the transistor Qt, and the node Nc becomes a source thereof. Since the gate and source are connected to each other, a current flowing from the node Nb to the node Nc is very small.

Alternatively, in a case where the reference voltage Vref is higher than the data voltage Vdata, the node Nb becomes the source of the transistor Qt, and the node Nc becomes the drain thereof. In this case, if the reference voltage Vref, the data voltage Vdata, the W/L of the transistor Qt are designed so as for the difference between the reference and data voltages Vref and Vdata to be smaller than the threshold voltage of the transistor Qt, a current flowing from the node Nc to the node Nb is very small. As a result, even though a voltage difference between the nodes Nb and Nc during the data input period occurs, the current flowing therebetween can be sufficiently small.

In addition, after the switching transistors Qs1 and Qs2 turn off, if the W/L of the transistor Qt is suitably designed by taking into consideration a voltage discharging speed of the node Nb, the transistor Qt can perform the same operations as the resistor R of FIG. 2.

Accordingly, the pixel circuit shown in FIG. 6 can also compensate for variations of the threshold voltages Vthd of the driving transistor Qd and the threshold voltage Vtho of the organic light emitting diode LD, so that the driving current I_{LD} depending on the data and reference voltages Vdata and Vref can flow into the organic light emitting diode LD.

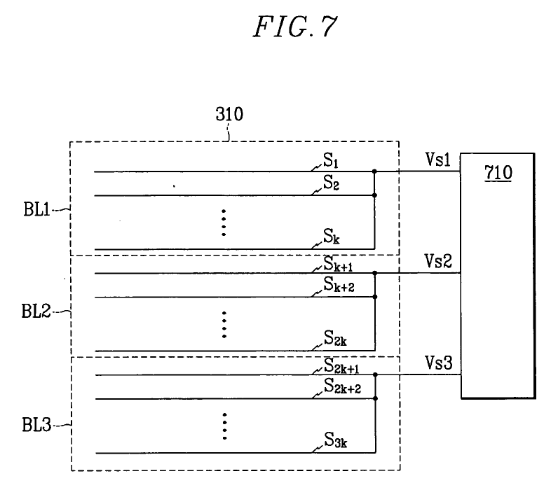

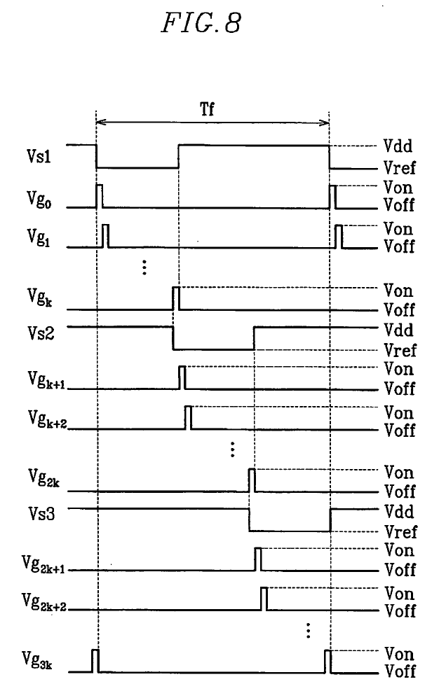

Now, an organic light emitting diode display device according to another embodiment of the present invention will be described in detail with reference to FIGS. 7 to 10.

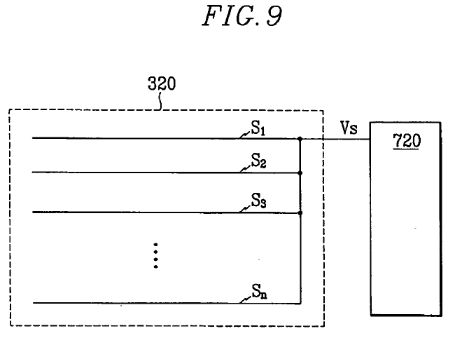

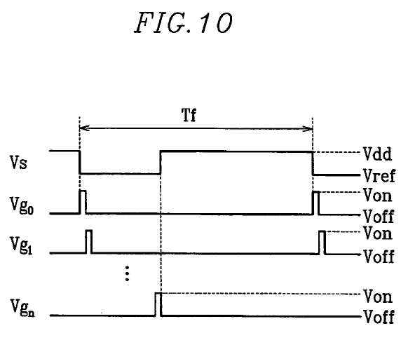

FIG. 7 is a schematic view showing another exemplary embodiment of an organic light emitting diode of the organic light emitting diode display device according to the present invention, and FIG. 8 is a timing diagram showing an exemplary embodiment of an example of a driving signal of the organic light emitting diode display device shown in FIG. 7. FIG. 9 is a schematic view showing another exemplary embodiment of an organic light emitting diode of the organic light emitting diode display device according to the present invention, and FIG. 10 is a timing diagram showing an exemplary embodiment of an example of a driving signal of the organic light emitting diode display device shown in FIG. 9.

Each of display panels 310 and 320 shown in FIGS. 7 and 9 is divided into at least one block. The light emitting signal lines S₁ to Sₙ in each block are electrically separated from each other, and the light emitting signal lines S₁ to Sₙ of the different blocks are electrically separated from each other.

Since the numbers of the blocks in the display panels 310 and 320 shown in FIGS. 7 and 9 are 3 and 1, respectively, all the light emitting signal lines S₁ to Sₙ are connected to each other. On the other hand, the display panel 310 shown in FIG. 7 may be assumed to be divided into “n” blocks.

The other components of the display panels 310 and 320 are same as those of the display panel 300 shown in FIG. 1, and the pixel structure of the display panels 310 and 320 are also substantially the same as that shown in FIG. 2 or 6.

As shown in FIGS. 7 and 8, light emitting signal lines S₁ to Sₖ, Sₖ₊₁ to S₂ₖ, and S₂ₖ₊₁ to S₃ₖ of first to third blocks BL1 to BL3 receive light emitting signals Vs1, Vs2, and Vs3 from a light emitting driver 710, respectively. Each of the blocks BL1 to BL3 operates in periods which are divided according to the light emitting signals Vs1, Vs2, and Vs3. The divided periods include a data input period where the light emitting signals Vs1, Vs2, and Vs3 are the reference voltage Vref and a light emitting period where the light emitting signals Vs1, Vs2, and Vs3 are the driving voltage Vdd.

In the data input period, the pixel rows are sequentially charged with a precharge voltage Vpre to receive data voltages Vdata. When the input of the data voltage Vdata to all the pixel rows in the block is completed, the light emitting period starts, and the organic light emitting diodes LD of all the pixel rows simultaneously emit light.

The light emitting signal Vs1 is equal to the reference voltage Vref when or before the 0-th scan signal Vg₀ becomes the high voltage Von. The light emitting signals Vs2 and Vs3 are equal to the reference voltage Vref when or before the last scan signals Vgₖ and Vg₂ₖ of the previous blocks BL1 and BL2 become the high voltage Von.

Therefore, the data input period of each block occupies about ⅓ of a frame time interval Tf, and the light emitting period thereof occupies the remaining time interval, that is, ⅔ Tf.

Since the detailed operations of the pixels PX are the same as those described with reference to FIGS. 2 and 6, detailed description thereof will be omitted.

Referring to FIGS. 9 and 10, the light emitting signal lines S₁ to Sₙ are applied with the light emitting signals Vs from the light emitting driver 720.

When the light emitting signal Vs becomes the reference voltage Vref, the pixel rows are sequentially charged with the precharge voltage Vpre to input the data voltages Vdata. When the input of the data voltage Vdata to the all the pixel rows is completed, the organic light emitting diodes LD of all the pixel rows simultaneously emit light.

In the organic light emitting diode display device shown in FIGS. 7 to 10, since emission can stop for a relative time interval, it is possible to obtain an impulsive driving effect. In addition, a duty ratio of the light emitting period can be determined according to characteristics of the display panel.

According to the present invention, three switching transistors, a driving transistor, a reference transistor, organic light emitting diodes, a resistor, and a capacitor are provided to store in the capacitor a voltage depending on a threshold voltage of the reference transistor and a data voltage, so that it is possible to prevent deterioration of image quality even though threshold voltages of the driving transistor and the organic light emitting diodes vary.

Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A display device comprising:
a light emitting element;
a driving transistor having a control port connected to a first node, an output port connected to a second node, and an input port, the driving transistor supplying a driving current to the light emitting element to emit light;
a reference transistor having a control port connected to the first node, an output port connected to a third node, and an input port;
a capacitor connected between the first and second nodes; and
a resistive element connected between the second and third nodes.

2. The display device of claim 1, further comprising a switching transistor which transmits a data voltage to the third node according to a scan signal.

3. The display device of claim 1, further comprising a switching transistor which connects the control port and the input port of the reference transistor according to a scan signal.

4. The display device of claim 1, further comprising a switching transistor which transmits a precharge voltage to the first node according to a front-stage scan signal.

5. The display device of claim 1, further comprising:
a first switching transistor which transmits a data voltage to the third node according to a scan signal;
a second switching transistor which connects the control port and the input port of the reference transistor according to the scan signal; and
a third switching transistor which transmits a precharge voltage to the first node according to a front-stage scan signal.

6. The display device of claim 5, wherein the input port of the driving transistor is applied with a light emitting signal, and the light emitting signal comprises a reference voltage and a driving voltage which is larger than the reference voltage.

7. The display device of claim 6, wherein the precharge voltage has a value which is larger than the data voltage and the reference voltage.

8. The display device of claim 7, wherein the data voltage is transmitted to the third node when the light emitting signal is the reference voltage.

9. The display device of claim 8, wherein the driving voltage is applied to the light emitting element, the light emitting signal being the driving voltage.

10. The display device of claim 6, wherein the resistive element comprises a semiconductor or a conductor.

11. The display device of claim 10, wherein the resistive element comprises amorphous silicon or a polysilicon.

12. The display device of claim 10, wherein the resistive element comprises amorphous silicon or a polysilicon doped with n+ type impurities.

13. The display device of claim 6, wherein the resistive element is constructed with a transistor connected to a diode.

14. The display device of claim 6, further comprising:
a scanning driver which generates the front-stage scan signal and the scan signal;
a data driver which generates the data voltage; and
a light emitting driver which generates the light emitting signal.

15. The display device of claim 14, further comprising a signal controller which controls the scanning driver, the data driver, and the light emitting driver.

16. The display device of claim 6, wherein the scan signal comprises a first voltage and a second voltage which is lower than the first voltage, and when the scan signal is the first voltage, a sum of the data voltage and a threshold voltage of the reference transistor is stored in the first node.

17. The display device of claim 6, wherein the scan signal comprises a first voltage and a second voltage which is lower than the first voltage, and when the scan signal is the second voltage, a voltage of the second node is substantially equal to that of the third node.

18. The display device of claim 6, wherein a structure of the reference transistor is substantially equal to that of the driving transistor.

19. The display device of claim 6, wherein a channel width of the reference transistor is smaller than that of the driving transistor.

20. The display device of claim 1, wherein the driving transistor and the reference transistor comprise amorphous silicon.

21. The display device of claim 1, wherein the driving transistor and the reference transistor are an n-channel thin film transistor.

22. The display device of claim 1, wherein the light emitting element comprises an organic light emitting layer.

23. A method of driving a display device comprising a driving transistor having a control port connected to a first node, an output port connected to a second node, and an input port; a reference transistor having a control port connected to the first node, an output port connected to a third node, and an input port; a light emitting element connected to the first node; a capacitor connected between the first and second nodes; and a resistive element connected between the second and third nodes, the method comprising:
applying a reference voltage to the input port of the driving transistor;
supplying a precharge voltage to the first node;
supplying a data voltage to the third node;
discharging a voltage charged in the first node through the reference transistor;
discharging a voltage charged in the third node through the resistive element; and
applying a driving voltage to the input port of the driving transistor.

24. The method of claim 23, wherein discharging the voltage in the first node comprises connecting the input port to the control port of the reference transistor.

25. The method of claim 23, wherein discharging the voltage in the second node comprises floating the input port of the reference transistor.

26. A display device comprising:
a light emitting element;
a first transistor having a first port, a second port, and a third port connected to the light emitting element;
a second transistor having a first port connected to the first port of the first transistor, a second port connectable to the first port of the first transistor, and a third port connectable to a data voltage; and
a capacitor connected between the first port of the second transistor and the third port of the first transistor.

27. The display device of claim 26, wherein the third port of the second transistor is alternately connected to the third port of the first transistor and the data voltage.

28. The display device of claim 26, further comprising a resistive element connected between the third port of the first transistor and the third port of the second transistor.

29. The display device of claim 26, wherein after a predetermined voltage larger than the data voltage is applied to the first port of the first transistor, the second transistor allows the second port and the third port thereof to be connected to the first port thereof and the data voltage, respectively, thereby forming a discharge path of a voltage of the first port of the first transistor.

30. The display device of claim 29, wherein after the discharge of the first port of the first transistor ends, the second transistor allows the second port and the third port thereof to be disconnected from the first port thereof and the data voltage, respectively, and the third port thereof to be connected to the third port of the first transistor, so that a voltage of the third port of the second transistor is equal to that of the third port of the first transistor.

31. The display device of claim 30, wherein the light emitting element emits light when the third port of the second transistor is connected to the third port of the first transistor, and the light emitting element does not emit light when the third port of the second transistor is connected to the data voltage.

32. A method of driving a display device comprising: a light emitting element; a first transistor having a first port connected to a first node, a second port connected to a second node and the light emitting element, and a third port;
a second transistor having a first port connected to the first node, a second port, and a third port; and a capacitor connected between the first node and the second node, the method comprising:
applying a first voltage for suppressing emission of the light emitting element to the third port of the first transistor;
connecting a second voltage higher than the first voltage to the first node;
after the second voltage is connected to the first node, disconnecting the first node from the second voltage;
after the first node is disconnected from the second voltage, connecting a data voltage lower than the second voltage to the second port of the second transistor;
after the first node is disconnected from the second voltage, connecting the first port and the third port of the second transistor;
after the second port and the first port of the second transistor are connected to the data voltage and the third port thereof, respectively, disconnecting the third port of the second transistor from the first port thereof;
after the second port and the first port of the second transistor are connected to the data voltage and the third port thereof, respectively, disconnecting the second port of the second transistor from the data voltage;
after the first port and second port of the second transistor are disconnected from the third port thereof and the data voltage, respectively, connecting the second port of the second transistor to the second node; and
applying a third voltage to the third port of the first transistor, thereby allowing the light emitting element to emit light.

33. A method of driving a display device comprising: a light emitting element; a first transistor having a first port, a second port, and a third port connected to the light emitting element; a second transistor having a first port connected to the first port of the first transistor, a second port, and a third port; and a capacitor between the first port and the third port of the first transistor, the method comprising:
applying a first voltage to the second port of the first transistor, thereby suppressing emission of the light emitting element;
charging a second voltage higher than the first voltage in the first port of the first transistor;
discharging the first port of the first transistor toward a data voltage lower than the second voltage through the second transistor, thereby reducing a voltage of the first port of the first transistor;
connecting the third port of the second transistor to the third port of the first transistor; and
applying a third voltage to the second port of the first transistor, thereby allowing the light emitting element to emit light.

34. A display device comprising a plurality of pixel rows of pixels,
wherein each of the pixels comprises:
a light emitting element;
a first transistor having a first port, a second port, and a third port connected to the light emitting element;
a second transistor having a first port connected to the first port of the first transistor, a second port connectable to the first port of the first transistor, and a third port alternately connected to the third port of the first transistor and a data voltage; and
a capacitor connected between the first port and the second port of the first transistor, and
wherein the pixels of at least two pixel rows simultaneously emit light.

35. The display device of claim 34, wherein the each of the pixels further comprises a resistive element connected between the third port of the first transistor and the third port of the second transistor.

36. The display device of claim 35, wherein after a predetermined voltage larger than the data voltage is applied to the first port of the first transistor, the second transistor allows the second port and the third port thereof to be connected to the first port thereof and the data voltage, respectively, thereby forming a discharge path of a voltage of the first port of the first transistor.

37. The display device of claim 36, wherein after the discharge of the first port of the first transistor ends, the second transistor allows the second port and the third port thereof to be disconnected from the first port thereof and the data voltage, respectively, and the third port thereof to be connected to the third port of the first transistor, so that a voltage of the third port of the second transistor is equal to that of the third port of the first transistor.

38. The display device of claim 37, wherein the light emitting element emits light when the third port of the second transistor is connected to the third port, and the light emitting element does not emit light when the third port of the second transistor is connected to the data voltage.

39. A display device comprising:
a light emitting element;
a driving transistor having an input port connected to one of a driving voltage and a reference voltage lower than the driving voltage, a control port, and an output port connected to the light emitting element; and
a capacitor connected to the control port and the output port of the driving transistor to charge a precharge voltage different from the driving voltage and, after that, store a control voltage depending on a data voltage.

40. The display device of claim 39, further comprising a reference transistor having a control port connected to the control port of the driving transistor and an input port selectively connected to the control port thereof, thereby being selectively connected to the data voltage.

41. The display device of claim 40, further comprising a switching transistor connected between the control port of the driving transistor and the precharge voltage.

42. The display device of claim 40, further comprising a switching transistor connected between the control port and the input port of the reference transistor.

43. The display device of claim 40, further comprising a switching transistor connected between the output port of the reference transistor and the data voltage.

44. The display device of claim 40, wherein the precharge voltage is higher than the reference voltage and the data voltage.

45. The display device of claim 44, wherein the precharge voltage is applied to the control port of the driving transistor when the reference voltage is applied to the input port of the driving transistor.

46. The display device of claim 44, wherein a voltage charged in the capacitor with precharge voltage is discharged toward the data voltage through the reference transistor.

47. The display device of claim 44, wherein the driving transistor outputs a driving current to the light emitting element according to the control voltage when the driving current is applied to the input port of the driving transistor.

48. A display device comprising:
a precharge voltage line which transmits a precharge voltage and is connectable to a first node;
a light emitting signal line which transmits a light emitting signal comprising a driving voltage and a reference voltage lower than the driving voltage;
a light emitting element connected to a second node;
a driving transistor having a control port connected to the first node, an input port connected to the light emitting element, and an output port connected to the second node;
a reference transistor having a control port connected to the first node, an input port, and an output port connected to a third node; and
a capacitor connected between the first node and the second node

49. The display device of claim 48, further comprising a resistive element connected between the second node and the third node.

50. The display device of claim 49, further comprising:
a first switching transistor connected between the output port of the reference transistor and a data voltage;
a second switching transistor connected between the input port and the control port of the reference transistor; and
a third switching transistor connected between the precharge voltage line and the first node.

51. A method of driving a display device comprising a driving transistor having an input port, a control port, and an output port; a capacitor connected between the control port and the output port of the driving transistor; and a light emitting element connected to the output port of the driving transistor, the method comprising:
applying a reference voltage to the input port of the driving transistor;
applying a precharge voltage higher than the reference voltage to the control port of the driving transistor, thereby charging the capacitor;
applying a data voltage lower than the precharge voltage to discharge a voltage charged in the capacitor in the step of charging, thereby charging the capacitor with a control voltage depending on the data voltage; and
applying a driving voltage higher than the reference voltage to the input port of the driving transistor.
